(19) United States
(12) Patent Application Publication
(10) Pub. No.: US 2009/0208155 A1
(43) Pub. Date: Aug. 20, 2009

(54) Swingarm bushing stabilizer for harley-davidson

(75) Inventor: Henry Kevin Blane, Murfreesboro, TN (US)

Correspondence Address: Henry Kevin Blane, 118 Fulwood Court, Murfreesboro, TN, 37130, US

(73) Assignee: Henry Kevin Blane, Murfreesboro, TN (US)

(21) Appl. No.: 12/378,406

(22) Filed: Feb. 13, 2009

Related U.S. Application Data
(60) Provisional application No. 61/065,553, filed on Feb. 14, 2008.

(51) Int. Cl. F16C 33/20

(52) U.S. Cl. 384/299; 280/124.116

(57) ABSTRACT

A motorcycle stabilization system comprising at least two pairs of cylindrical bushing members comprising of a rigid polymer which is inserted into opposite sides of the swing arm of a motorcycle; each pair having a first member being cylindrical in profile, a beveled nose section and an axial bore that is inserted via the beveled nose section into the swing arm; and a second cylindrical member being inserted behind the first member, including a rear radial ring which aligns with the rubber mount on the swing arm.

### FIELD OF THE INVENTION

The present invention is directed toward an improved swingarm (rear fork) Bushing/Stabilizer for Harley-Davidsons, specifically for models FLR, FLHR, FLHT, FLT, FXR's or Harley-Davidson style (rubber mount) motorcycle frames.

### BACKGROUND OF THE INVENTION

Motorcycle instability is one of the chief causes of motorcycle accidents throughout the world. Unstable rear frames and axles, particularly in larger motorbikes, such as those made by Harley-Davidson, lead to hundreds of injuries and deaths. There are major lawsuits being instituted against large motorcycle manufacturer's for accidents happening as a result of this instability.

There have been a number of patents directed to the field of motorcycle frame attachments. U.S. Pat. No. 6,131,684 to Ticknovich discloses an improved motorcycle frame having both a first part and a second part mounted for pivotal movement relative to the first part about an axis. The improvement includes a cushioned bushing operatively arranged between the two frame parts for enabling pivotal movement therebetween and for damping vibrations transmitted therebetween. The bushing has a rod substantially coincident with the pivotal axis; a first cushion provided with a blind recess for receiving one marginal end portion of the rod; a second cushion provided with a blind recess for receiving another marginal end portion of the rod; and compression means for exerting axial forces on the cushions to create forces between the cushions and the rod marginal end portions. In a preferred embodiment, the cushions are made of dual-durometer urethane materials.

U.S. Pat. No. 6,378,644 to Brown discloses a motorcycle swing arm support assembly including a bushing extending through a portion of the swing arm and the frame, a spacer, and a bolt extending through the frame, swing arm, bushing, spacer, and a portion of the motorcycle transmission case. The drive belt of the motorcycle defines a loop around the spacer. The drive belt may be removed without dropping or raising the transmission case by partially retracting the bolt so that the spacer may be removed and the belt replaced. The bushing has an elongated portion that may be extended through the swing arm and the frame to pivotally connect the frame and swing arm during the assembly process.

U.S. Pat. No. 6,899,193 to Anibas discloses a device for providing adjustable, deployable, controlled flex and lateral suspension movement to a motorcycle chassis. This is accomplished by a swingarm pivot mechanism, that when operated, variably allows the swingarm member to move laterally, controlled by flexure members, and constrained within selected limits. The mechanism is controlled by a logic unit acting on inputs such as lean angle, road speed, transmission gear position, engine speed, throttle position, brake application, suspension position, and a rider override switch. In another embodiment, the mechanism is used without an actuator, and is manually adjusted for flex and performance per conditions and rider preference.

U.S. Pat. No. 5,064,216 to Hynds discloses an end link assembly which includes an elongated link terminating in a barrel portion at one end and a ring portion at the other end. The elastomeric bushing has a pair of flexible annular walls projecting outwardly from an outer surface is mounted at the ring portion of the link. A stabilizer bar is press fitted into the bushing. The barrel portion is mounted to the control arm by a fastener. During operation, the bushing provides a working angle large enough to accommodate the movement between the stabilizer bar and the link.

U.S. Pat. No. 6,893,034 to Fader discloses a stabilizer bar assembly including bushings secured to the bar, such that there is no relative rotary movement between an inner surface on the bushings and an outer surface on the bar. In one example embodiment, the bushings are adhesively secured to the bar. In another example, the bushings are molded directly onto the bar. In example embodiments adhesively securing the bushing to the bar, a post bond adhesive is used and cured during a paint curing step after paint has been applied to the bar. Various example assemblies and methods of manufacturing are disclosed.

Although there have been a number of patents directed to the field of frame attachments for motorcycles, there has not been a patent that has adequately addressed that instability issue caused in larger motorbikes.

### OBJECTS AND SUMMARY OF THE INVENTION

It is an object of the present invention to provide a novel stabilization system for a motorcycle.

It is a further object of the invention to provide a motorcycle stabilization and handling system which can be retrofitted onto an existing motorcycle.

It is a further object of the present invention to provide a novel handling and stabilization system for a motorcycle which comprises two matable members.

In accordance, the present invention discloses a motorcycle stabilization system that comprises at least two cylindrical bushing members which are inserted into the swing arm of a motorcycle. The first member is cylindrical in profile and has a beveled nose section and an axial bore. It is inserted via the beveled nose section into the swing arm. The second cylindrical member is inserted behind the first member and includes a rear radial ring which aligns with the rubber mount on the swing arm.

In a further embodiment, the present invention is a motorcycle stabilization system that comprises at least two pairs of cylindrical bushing members which are inserted into opposite sides of the swing arm of a motorcycle. Each pair of cylindrical bushing members has a first member being cylindrical in profile a beveled nose section and an axial bore. It is inserted via the beveled nose section into the swing arm. The second cylindrical member is inserted behind the first member and includes a rear radial ring which aligns with the rubber mount on the swing arm.

In still a further embodiment, the present invention is a motorcycle stabilization system that comprises at least two pairs of cylindrical bushing members consisting of a rigid polymer which is inserted into opposite sides of the swing arm of a motorcycle; each pair has a first member being cylindrical in profile, beveled nose section and an axial bore. It is inserted via the beveled nose section into the swing arm. The second cylindrical member is inserted behind the first member and includes a rear radial ring which aligns with the rubber mount on the swing arm.

### DESCRIPTION OF THE FIGURES

FIG. 1 is a side perspective view of the present invention as shown on the left hand side of a motorcycle.

FIG. 2 is a side perspective view of the present invention as shown on the right hand side of a motorcycle.

FIG. 3 is a perspective view of the insert pieces of the present invention.

FIGS. 4 and 5 illustrate the inserts of the present invention.

### DESCRIPTION OF THE PREFERRED EMBODIMENT

The present invention is described with reference to the attached Figures, wherein the same numbers are used where applicable.

Specifically, the present invention is directed to a swing arm bushing system which is designed to be installed on a swing arm mounting bracket of a motorcycle. It is designed to be installed inside of the rubber mount that is aligned with the hole on the rear for bracket, so as to remove lateral movement of this arm, improving on a users handling of a large motorbike.

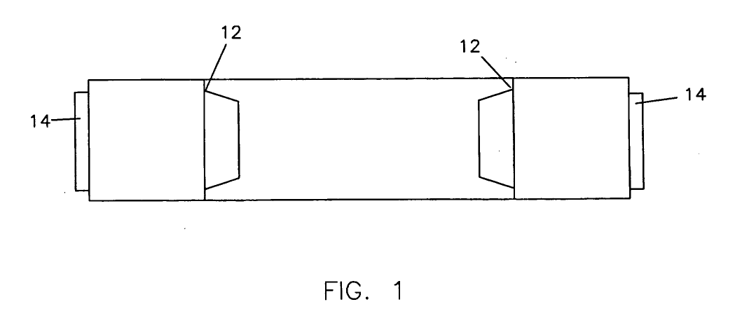

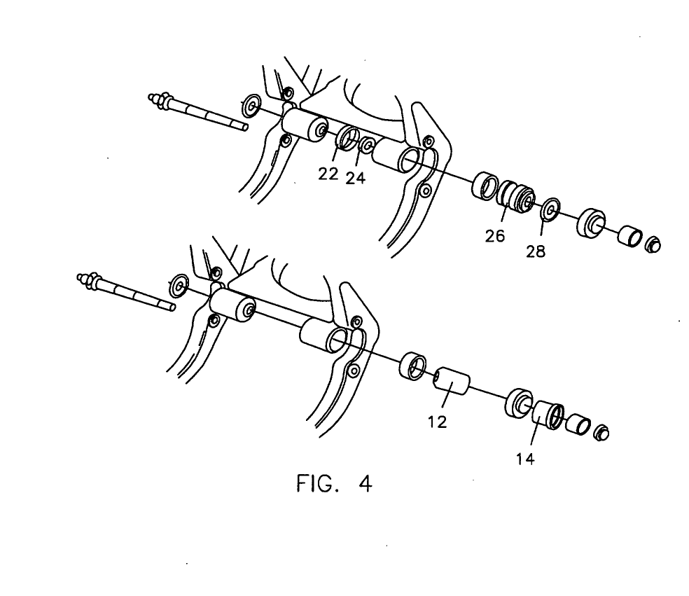

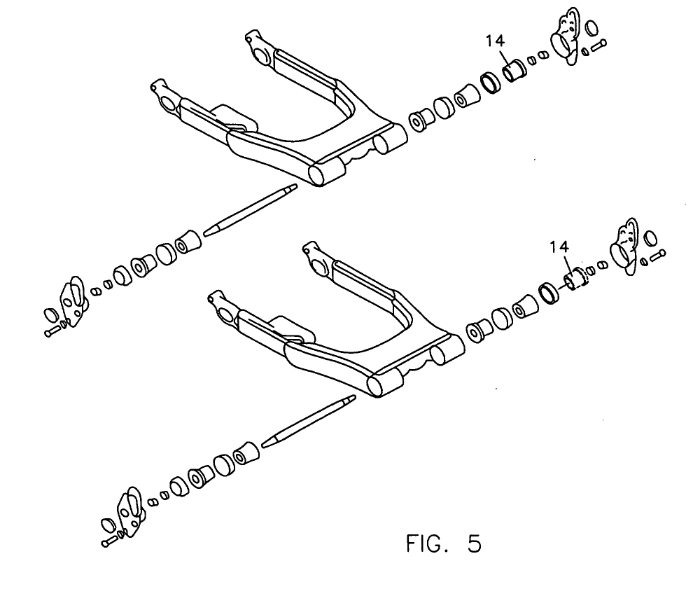

Referring to FIGS. 1 through 4, the invention comprises two cylindrical bushing members 12, 14 which are inserted into the swing arm 16. The first member 12 is cylindrical in profile, has a beveled nose section 18 and an axial bore 20. It is inserted via the beveled nose section 18 into the swing arm and replaces the elements 20, 22, 24, 26 and 28. This configuration appears most particularly in the 1980 through 2001 Harley Davidson models.

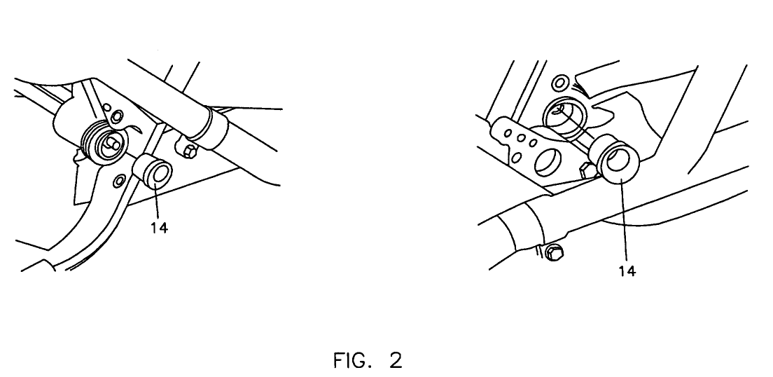

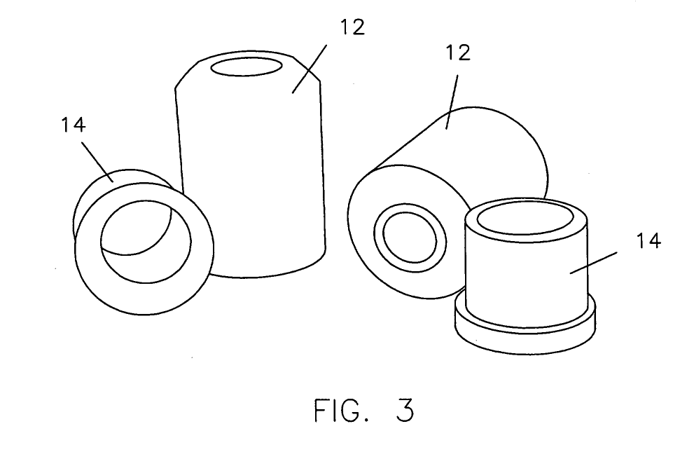

Referring to FIGS. 2 to 3, the invention is shown in the context of a second piece 14. The second cylindrical member 14 is inserted behind the first member and includes a rear radial ring 22 which aligns with the rubber mount 26 on the swing arm. In an alternative embodiment, the invention can be used on Harley Davidsons from 2002 to present.

The cylindrical members 12, 14 are preferably constructed from a rigid polymer, such as Delrin. The interior axial of the first and second members is coated with hardened steel.

The invention is specifically designed as an improved swing arm bushing stabilizer for Harley-Davidsons, specifically for models including the FXR, FLT, and FLHR frames, as well as any Harley-Davidson styled rubber mount motorcycle frame. It is designed to replace all OEM style bushings, nylon washers, spacers, and plastic retaining rings.

The present invention thus provides increased stabilization for safer handling of the motorcycle. It removes lateral movement of the swing arm, improves handling, replaces original equipment, improves dampening and aligns the engine and transmission in the frame.

The present invention has been described with reference to the preferred embodiment. The true nature and scope of the present invention is to be determined with reference to the claims appended hereto.

1. A motorcycle stabilization system comprising:
at least two cylindrical bushing members which are inserted into the swing arm of a motorcycle;
the first member being cylindrical in profile, having a beveled nose section and an axial bore, and being inserted via the beveled nose section into the swing arm; and
a second cylindrical member being inserted behind the first member and including a rear radial ring which aligns with the rubber mount on the swing arm.

2. The motorcycle stabilization system of claim 1 wherein the cylindrical members are preferably constructed from a rigid polymer.

3. The motorcycle stabilization system of claim 2 wherein the rigid polymer comprises delrin.

4. A motorcycle stabilization system comprising:
at least two pairs of cylindrical bushing members which are inserted into opposite sides of the swing arm of a motorcycle;
each pair having a first member being cylindrical in profile, having a beveled nose section and an axial bore, and being inserted via the beveled nose section into the swing arm; and
a second cylindrical member being inserted behind the first member and including a rear radial ring which aligns with the rubber mount on the swing arm.

5. A motorcycle stabilization system comprising:
at least two pairs of cylindrical bushing members, comprised of a rigid polymer, which are inserted into opposite sides of the swing arm of a motorcycle;
each pair having a first member being cylindrical in profile, a beveled nose section and an axial bore, and inserted via the beveled nose section into the swing arm; and
a second cylindrical member being inserted behind the first member and including a rear radial ring which aligns with the rubber mount on the swing arm.
